(19) United States
(12) Patent Application Publication
(10) Pub. No.: US 2004/0089803 A1
(43) Pub. Date: May 13, 2004

(54) Directing and focusing of charged particles with conductive traces on a pliable substrate

(75) Inventor: Peter Foley, Los Altos, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: BIOSPECT, INC., South San Francisco, CA

(21) Appl. No.: 10/293,237

(22) Filed: Nov. 12, 2002

(51) Int. Cl. H01J 49/04

(52) U.S. Cl. 250/288

(57) ABSTRACT

An improved mass spectrometer makes use of flexible circuit-board technology for directing charged particles through an interface from an ionization source to an analyzer of a mass spectrometer. A heated focusing structure may reduce or eliminate the use alternative desolvation techniques, such as use of heated capillaries and/or drying gas, to desolvate ions.

### BACKGROUND OF THE INVENTION

The present generally relates to devices and methods for manipulating charged particles. In one exemplary embodiment, the invention provides a mass spectrometer or other instrument having a tapering ion capture funnel made by rolling a pliable circuit or forming conductive traces within a funnel, the ion capture funnel typically positioned to enhance the efficiency of ion transfer from an ion source into a mass spectrometer analyzer.

Mass spectrometers are widely used in research for characterization and identification of compositions and biological substances. Mass spectrometers often analyze variations or dispersion of ion movement under electric or magnetic fields, and are particularly useful for determining properties such as mass or mass-to-charge ratio of ions.

A wide variety of ionization sources have been developed, with many of these being intended for ionization of biological compounds. Most early ion sources made use of vacuum chambers in which the compounds of interest are ionized at very low pressures. Electrical field ionization, thermal ionization, photo-ionization, and other techniques have been used in vacuum environments to ionize particles of interest. More recently, characterization of some complex biological particles has been found to benefit from an ionization source having higher pressures, with particular advantages being found for ionization processes which are effective at pressures ranging from atmospheric down to a high vacuum. Such moderate pressure environments may have benefits for analysis of large complex biological substances such as proteins, and specific ionization techniques have been found effective in these regimes. Electrospray ionization (ESI) is among the most popular ionization techniques for use at pressure above 0.1 millibar, although Matrix Assisted Laser Desorption Ionization or “MALDI” and related techniques have also found beneficial applications in atmospheric and intermediate pressure regimes.

A variety of analyzer technologies have been developed, with some analyzers measuring lateral deflection of an ion stream. Others measure the travel time of an ion along an axis, with a particularly promising analyzer of this form being the Hadamard-Transform Time of Flight mass spectrometer (“HT-TOFMS”). Regardless of the specific form of the analyzer, most mass spectrometer analyzers make use of electrical fields for manipulation of the ions using ion optics, multi-pole devices, mass filters, acceleration electrodes, reflections, and the like. These ion manipulation structures often benefit from a vacuum environment so as to avoid or reduce collisions between the ions and any ambient gas molecules within the analyzer chamber.

Time-of-Flight (“TOF”) mass spectrometers generally measure the time of progression for ions along an ion flight path to determine the ion mass. Mass resolution is generally enhanced by increasing the length of the ion flight path. Unfortunately, the longer the ion flight path through the analyzer, the larger (and more expensive) the analyzer structure becomes, and the greater the volume that must be maintained under vacuum. To allow the use of moderately sized components, many time-of-flight mass spectrometers include a reflector or reflectron. A reflector might be described as the ion optical equivalent of a mirror: a series of electrodes arranged along the ion flight path so as to substantially reverse the direction of travel of the ions. Use of such a folded ion flight path allows a significantly greater path length for a given size of the analyzer vacuum chamber, thereby limiting the vacuum pump requirements and the like. One advantageous reflector for use within the vacuum chamber of an analyzer makes use of printed circuit board (PCB) technology on a thin, flexible substrate. The substrate may be rolled into a tube to form the electrodes of the reflector.

Most TOF mass spectrometers make use of an interface with a relatively small orifice between different pressure regions so as to help maintain pressure separation. An atmospheric pressure interface between an electrospray ionization source and the vacuum chamber of a mass spectrometer analyzer will typically have a quite small orifice to accommodate an atmospheric pressure within the ionization chamber. An atmospheric pressure interface may also have one or more intermediate chambers or differential pumping zones at intermediate pressures between that of the ion source and the analyzer. While the lower pressure in the analyzer may tend to help entrain and transport both bath gas and ions from within the ionization chamber, this can also result in large and/or uncharged particles being pulled into the analyzer. As a result, some mass spectrometers use a counter-flow of gas adjacent the ionization interfaces to selectively limit the stream of particles to the ions of interest. The ion flight path may also traverse a heated capillary to thermally desolvate fluid droplets.

While generally successful, existing mass spectrometer structures and their ion transfer techniques are complex, bulky and exorbitantly expensive. Simpler mass spectrometers are available, but these units often suffer from a relatively poor performance, due in part to limited (and insufficiently selective) analyte ion transport from the ion source into the analyzer structure. It has recently been proposed to include an ion funnel within the mass spectrometer system so as to generate both a DC and an RF field that focuses charged particles towards an orifice of the interface. By positioning such a funnel within a chamber having a pressure between 0.1 millibar and 1 bar, and by applying a DC potential gradient along the ion funnel, these new funnel structures can improve the efficiency of transmission of the generated ions into the lower pressure components of a mass spectrometer. Unfortunately, the ion funnel structures proposed to-date are fairly complex. While offering significant potential advantages in ion transmission efficiency, the inclusion of a complex ion funnel to an already complicated mass spectrometer system will further increase costs and limit the use of these research tools.

Despite their limitations, mass spectrometers have evolved over the years to highly accurate (albeit complex) research tools. These instruments have also found a variety of applications in industry, particularly for quality control and other testing. Beyond their traditional role in research, some medical professionals are now investigating the use of mass spectrometers for diagnosis of diseases. Additionally, recent advances in proteomics have, at least in part, been based on mass spectrometry. Some of this proteomics research indicates that the presence of even small quantities of a particular protein (or other marker substance) may provide a highly reliable and early detection of a specific biological state, such as cancer or other disease states.

Further improvements in existing mass spectrometry instruments for use by researchers will continue to be beneficial. Moreover, it may be possible to transfer this research into improved healthcare. This technology transfer may involve a fundamental shift: Medical diagnosis may in the future make use of mass spectrometry, which has basically been a research tool. To enable this very different use, the cost and complexity of the existing research mass spectrometers should be decreased dramatically. While a fundamental advancement in the technology would clearly help, numerous incremental improvements in mass spectrometer instruments, and in methods for their production, may be combined to significantly increase the availability of this potentially advantageous early-warning medical diagnostic tool.

For the reasons given above, it would be desirable to provide improved devices, methods, and methods for fabricating devices that manipulate charged particles. It would be particularly beneficial to provide improved methods for fabricating mass spectrometry instruments and their components, especially if these improvements facilitated the production and assembly of what has previously been a complex and bulky research instrument.

### SUMMARY OF THE INVENTION

The present invention generally provides improved devices, systems, methods, and methods for making devices for manipulation of charged particles. In particular, exemplary embodiments of the invention include an improved mass spectrometer making use of circuit-board technology for selectively directing charged particles through an interface between chambers, for example, from an ionization source to an analyzer of a mass spectrometer.

In a first aspect, the invention provides a method for fabricating an instrument. The method comprises forming electrically conductive traces on a surface of a substrate, and forming a channel with the substrate about an axis. The substrate is positioned along an ion flight path traversing an interface between first and second chambers. The channel of the positioned substrate extends upstream of the interface and around the path with the conductive traces separated axially and extending circumferentially about the flight path. A potential source is coupled to the traces such that ions from the first chamber are focused along the axis by electrical potentials of the traces as the ions traverse through the channel and advance into the second chamber via the interface.

Optionally, the substrate is shaped so as to form a tapering channel having a first channel end and a second channel end smaller than the first end. The substrate will often be positioned with the first end upstream of the second along the ion flight path. The substrate may advantageously be pliable, and may be bent by wrapping the substrate around a tapering mandrel so that the traces are disposed on an inner surface of the wrapped substrate. The tapering mandrel will often have a conical shape, and the mandrel may be removed from within the wrapped substrate prior to positioning of the substrate along the ion flight path. Alternatively, the substrate may also be rigid, optionally comprising a ceramic or other high-temperature material on which conductive traces are formed. The substrate will often have a connector portion extending from an outer edge of the wrapped substrate. The coupling of the potential source may be effected by coupling the connector portion of the substrate to a corresponding connector of the potential source.

The interface will typically include an orifice separating an ion source environment from an analyzer environment in a mass spectrometer system. The electrical potentials will typically comprise DC and/or RF potentials. Ions may be focused from a first ion stream cross section adjacent an upstream end of the substrate to a second ion stream cross-section adjacent the orifice by the electrical potentials applied to the traces. Axially adjacent traces will generally be out-of-phase. The second ion stream cross-section may be significantly more concentrated than the first ion stream cross-section. Optionally, ions may be heated as they travel within the substrate.

In another aspect, the invention provides an instrument comprising an ion source generating ions in a source environment. An analyzer receives the ions into an analyzer environment. An interface disposed along an ion flight path between the source and the analyzer may, at least in part, separate the analyzer environment from the source environment. An ion concentrator may be disposed along the ion flight path upstream of the interface. The ion concentrator may have a pliable substrate with a plurality of electrically conductive traces. The substrate can have an upstream end and a downstream end with an axis therebetween along the ion flight path. The substrate will also have a substrate surface bending about the axis so as to define an ion channel. The traces extend circumferentially along the substrate surface and are separated axially. Circuitry coupled to the traces applies electrical potentials for focusing the ions from an initial cross section entering the channel adjacent the upstream end to a focused cross-section exiting the channel adjacent the downstream end.

Optionally, the substrate may be thermally conductive, and a heater may extend along at least a portion of the substrate so as to desolvate ions traveling through the channel. The source environment can comprise a source pressure during ionization, while the analyzer environment comprises an analyzer pressure during analysis. The analyzer pressure will often be lower than the source pressure. The interface may comprise an orifice having a cross-section such that a pressure reduction occurs along the ion flight path. The focusing effected by the potentials can urge ions traveling toward the interface from within the source chamber radially inwardly, so that they tend to traverse through the orifice. Typically, the traces will define at least five circumferential loops. The number of loops may vary significantly based on, for example, whether the desired field shape comprises a linear or a curved field. The width of the individual trace loops may also be tailored to the particular application, with many embodiments having between 2 and 10 loops per inch, with the loop traces optionally being up to (or even more than) ½ inch wide. Circuitry typically applies RF potentials to the traces so that potentials of axially adjacent loops are out of phase. The RF potentials will have amplitudes and frequencies so as to induce pseudo potential repulsion between the ions and surfaces of the loops. Differing DC potentials may be superimposed to the various loops by the circuitry so as to urge the ions along the stream.

When the substrate structure is disposed in a chamber having a pressure greater than that of a high vacuum, the substrate material may become charged as the ions traveling along the flight path collide with the ambient gases and are directed onto the substrate material. This ion collision charging may deleteriously effect the intended electrical fields generated by the traces. Hence, in some embodiment the substrate may comprise a material having a resistivity higher than the traces and sufficiently low to allow ion collision charges imposed on the substrate during use to be drained. Optionally, a collision charge drain conductor may be coupled to the substrate, to allow draining of the ion collision charge from the substrate.

In another aspect, the invention provides an improved focusing device comprising an ion concentrator disposed along an ion flight path having an axis. The ion concentrator has an upstream and a downstream end with an ion channel extending along the axis therebetween. A plurality of electrical conductors are disposed along the channel, each electrical conductor extending circumferentially about the ion flight path. The electrical conductors define a first ion stream cross-section adjacent to the upstream end and a second ion stream cross-section adjacent the downstream end, the second cross-section being smaller than the first cross-section. The electrical conductors may be axially separated so that adjacent electrical conductors accommodate axially out of phase RF potentials. A heater may be disposed along the ion channel so as to transmit thermal energy to ions traversing the channel so as to desolvate the ions.

Optionally, the electrical conductors may each comprise a metal body having a passage therethrough, with the passages defining the ion channel. Alternatively, the conductors may comprise traces of electrically conducting material disposed on a non-conductive substrate, with the substrate extending around the ion channel. Such non-conductive substrates may optionally comprise a ceramic material. The heater may comprise an electrical resistor disposed around the channel or impregnated into the ceramic material. Preferably, the thermal energy provided to the ions from the heater is sufficient to desolvate the ions without the use of a heated capillary, a drying gas, and/or without heating the entire chamber. Advantageously, this may allow mass spectrometers with both acceptable ion capture efficiency and desolvation without having to resort to a heated capillary structure or gas flow.

### BRIEF DESCRIPTION OF THE DRAWINGS

FIG. 1 schematically illustrates a cross-section of a mass spectrometer having an ion focusing component formed from a pliable substrate, according to the principles of the present invention.

FIG. 1A schematically illustrates an ESI source for use with the mass spectrometer of FIG. 1.

FIG. 2 schematically illustrates a plan form of a pliable substrate having electrically conductive traces thereon for use in the mass spectrometer of FIG. 1.

FIG. 3 is a schematic illustration of a tapering mandrel for forming an ion focusing device according to a method of the present invention.

FIG. 4 schematically illustrates a method for forming an ion focusing component of a mass spectrometer by wrapping the tapering mandrel of FIG. 3 with the pliable substrate and electrical traces of FIG. 2.

FIG. 5 schematically illustrates coupling of an ion focusing apparatus formed with a flexible substrate to both RF and DC potential sources.

FIG. 6 illustrates an alternative ion focusing device having a resistive heater for desolvating ions.

FIG. 7 schematically illustrates an alternative ion focusing/desolvating structure, according to the principles of the present invention.

### DETAILED DESCRIPTION OF THE INVENTION

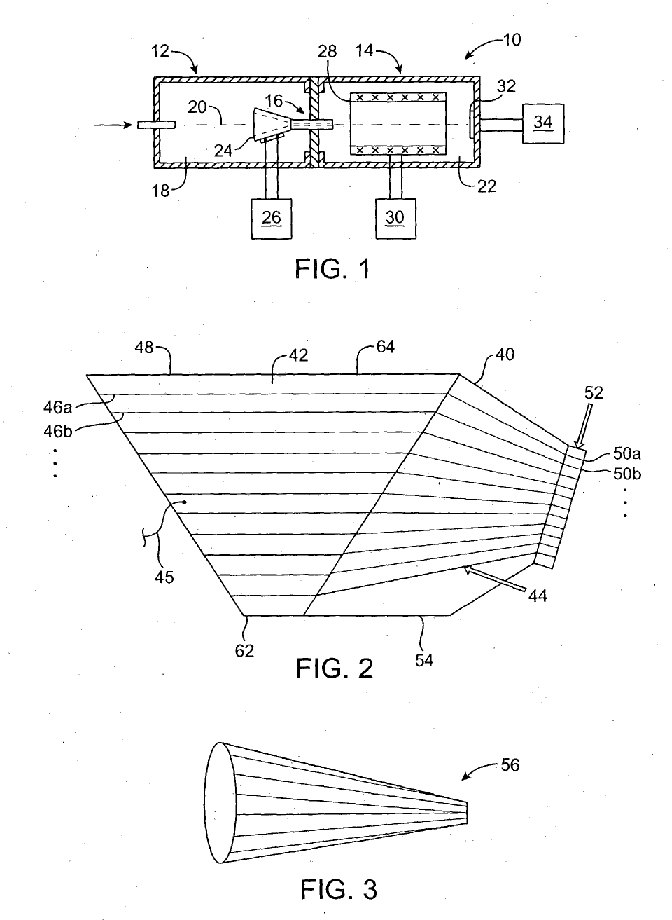

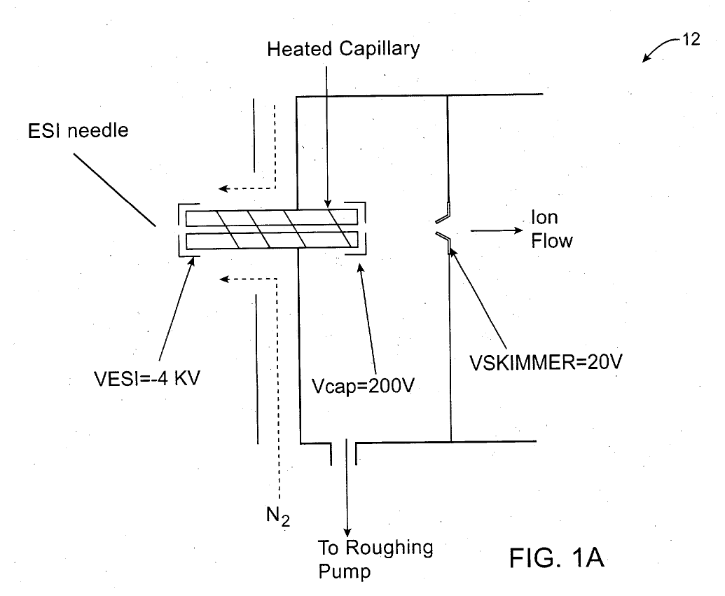

Referring now to FIG. 1, a mass spectrometer system 10 generally includes an ion source 12 coupled to an analyzer 14 by an interface 16. In general terms, a compound or substance of interest is introduced into a chamber 18 of ion source 12, and is ionized within an environment contained by that chamber. The ions, being mutually repulsive, will tend to disperse at least to some extent within chamber 18, but (through pneumatic and/or electrostatic assistance) will generally travel along an ion flight path 20 to a chamber 22 of analyzer 14. An ion focusing assembly 24 focuses the dispersed ions within chamber 18 along an axis of ion flight path 20. This increases the number of ions advancing from within ionization chamber 18 through interface 16 into the analyzer 14. A focusing driver 26 is electrically coupled to focusing assembly 24, with electrical potentials applied by the driver providing the focusing energy.

Ionization chamber 18 will often be at a significantly higher pressure than chamber 22 of analyzer 14. Interface 16 helps to separate in the different environments in these two chambers, the interface often having an orifice which remits flow of gasses from the ionization chamber into the analyzer. Optionally, the orifice may be incorporated into focusing assembly 24, with the orifice basically being defined by the smallest aperture along the focusing assembly. Alternatively, a capillary may extend along ion flight path 20 from focusing assembly 24. While a drying gas, such as nitrogen, may be used to desolvate droplets traveling along ion flight path 20, the invention encompasses systems lacking such known heated capillaries or drying gas. For example, as will be described in detail below, some or all of focusing assembly 24 may be heated sufficiently to desolvate droplets without having to resort to the heated capillaries of the prior art. Non-heated capillaries may be included, as may one or more intermediate chambers along ion flight path 20 between ionization chamber 18 and the chamber 22 of analyzer 14. Similarly, multiple orifice structures may also be provided, as might intermediate environment controls for intermediate pressure chambers, backflow systems in which counter flowing gasses are directed against ions flowing along ion flight path 20 and the like. In general, minimizing and/or avoiding the number of such intermediate structures and systems helps decrease the cost and complexity of the overall mass spectrometry system.

Ionization source 12 will often comprise an electrospray ionization source (ESI). The sample fluid may be introduced via a micro fluidic capillary electrophoreses chip, nano-electrospray or standard electrospray ionization nozzles, or any of a wide variety of alternative structures. Ionization may also be induced electrically by light energy, and/or the like. When light energy is used, at least in part, to effect ionization, the sample may be included in a matrix using known Matrix Assisted Laser Desorption Ionization (MALDI) techniques, Surface Enhanced Laser Desorption Ionization (SELDI), or the like. In many embodiments, the pressure within ionization chamber 18 will be above about 0.1 millibar, optionally being at (or even above) atmospheric pressure.

Once the ions enter chamber 22 of Analyzer 14, they will be manipulated by electrical fields generated with ion manipulation system 28 using analyzer driver 30. Chamber 22 may be defined by a series of sub-chambers of progressively lower pressures. The structures (and the rest of the structure of mass spectrometer system 10) is schematically shown in FIG. 1, as it will typically have significantly greater complexity than illustrated. For example, the analyzer structure will often include a reflector such as that described in U.S. Pat. No. 6,363,383, as issued on Apr. 9, 2002 for a “Flexboard Reflector.” For Hadamard transform time-of-flight mass spectrometer systems, an ion beam manipulation device may be disposed in chamber 22, the ion modulator ideally comprising a Bradbury Nielson gate such as that described in provisional application 60/315,970, filed on Aug. 29, 2001 and entitled “Method for Producing Finely Spaced Bradbury-Nielson Gates.” Both of these references are incorporated by referencing to the present application.

For time-of-flight mass spectrometer systems, a detector 32 will typically transmit a signal to a data acquisition and analysis system 34, with the signal typically indicating transit time of the ions along the ion flight path 20 through analyzer 14. Alternative detector and data systems may also be used, including ion detection of the ion location in a beam deflection analyzer. Regardless, chamber 22 will typically contain an environment that is at significantly lower pressure than that of ionization source 12, with the analyzer environment typically having a pressure below 0.1 millibar. One suitable analyzer structure is shown in U.S. Pat. No. 6,300,626, the disclosure of which is incorporated herein by reference. A schematic of an ESI source is provided in FIG. 1A.

The structure and method for fabrication for ion focusing assembly 24 can be understood with reference to FIGS. 2 through 4. FIG. 2 schematically illustrates a precursor sub-assembly comprising a flexible substrate 40 having a surface 42. A pattern of conductive material or traces 44 is disposed along surface 42 of substrate 44. Advantageously, the pattern of traces may be precisely defined using circuit board fabrication technologies developed for flexible circuit boards. Hence, substrate 40 will often comprise a polyimide or other polymer film suitable for use as a circuit board substrate. Exemplary films are commercialized by Dupont as Kapton™ Films and are often provided with a thickness of about 0.002 inches. Conductive traces 44 (for example) have widths of about 0.008 inches (or more) and a thickness of about 0.001 inches, the traces optionally comprising a conductive metal such as copper or the like. Traces 44 may be defined by selective deposition of the conductive material on substrate 42, by selective removal or etching of a layer of conductive material deposited on surface 42, or the like.

A variety of alternative substrate materials may also be employed. In some embodiments, particularly those having heaters or other structures for desolvating ions traveling through assembly 124, the substrate may comprise a good heat conductor and/or a high temperature material. In some embodiments, the substrate may not be pliable. Optionally, the substrate may comprise a printed circuit board material, a ceramic or glass material, or the like. When assembly 124 is disposed at least partially within a chamber having an ambient pressure which is greater than that of a high vacuum, such as in an atmospheric pressure electrospray ionization chamber or an intermediate chamber disposed between a high pressure ionization chamber and the vacuum of the mass spectrometer, the substrate may become charged as energetic, charged ions collide with the substrate material. These collisions may result from deflecting collision between the energetic ions and the ambient gases within assembly 124 or the like. This collision induced charging may deleteriously effect the intended electrical fields generated by the traces. Hence, the use of substrate materials that will not become charged, or the use of semiconductor materials which can drain the charge away may be beneficial. These ion collision induced charges may be lower and/or non-existent when the substrate material is disposed within a high vacuum, the beam is located within a center of a substrate and separated from the substrate by a significant distance, or the like. Suitable materials which may allow the ion collision charge to be drained away sufficiently to inhibit deleterious effects on the desired beam concentrating fields will generally have a resistance higher than that of the traces, but sufficiently low to allow the ion collision charge to be drained. Such materials may comprise a substrate coating such as titanium-dioxide, and/or a polyimide such as DuPont Vespel™, which can be doped with a variety of materials so as to confer the desired resistivity. An ion collision drain conductor 45 may be coupled to the substrate so as to drain the charge as schematically illustrated in FIG. 2.

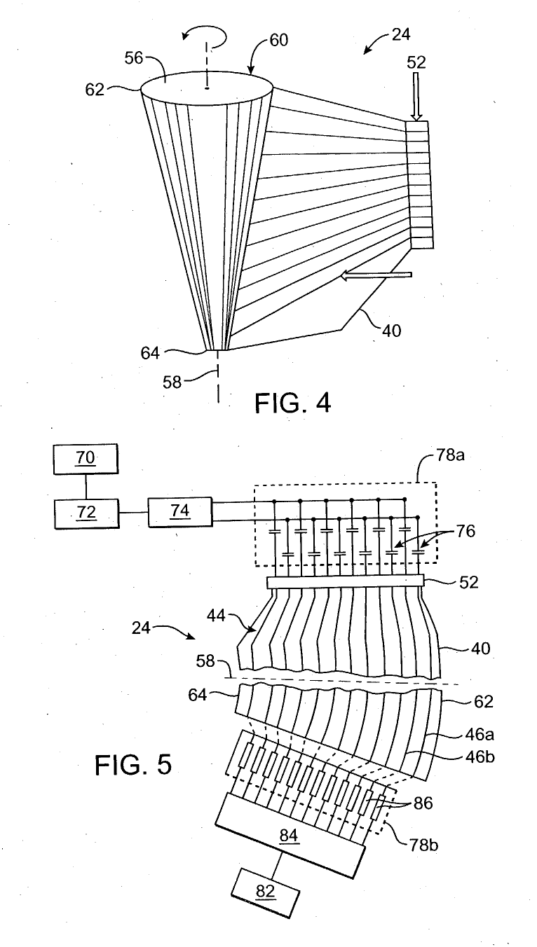

Traces 44 may comprise a series of parallel conductive lines 46a, 46b, . . . along a body portion 48 of substrate 40. These parallel lines may be electrically coupled to associated connectors 50a, 50b . . . disposed at a connector portion 52 of the substrate 40. Coupling may be facilitated by the presence of an intermediate portion 54 of the substrate. Conductive lines 46a, 46b . . . will often be substantially parallel, and may be arranged so as to form connective rings when body 48 is rolled over a tapering mandrel 56 about an axis 58, as shown in FIGS. 3 and 4. To provide this ring conductor configuration, conductive lines 46 may form arc-like shapes along body 48.

Once substrate 40 has been bent to the desired form, the shape of body portion 48 may be fixed. For example, one or more layers of a reinforcing material such as fiberglass may be deposited over the substrate as described in U.S. Pat. No. 6,369,383. Alternatively, the shape of substrate may be fixed using a heat activated or other adhesive, fasteners through multiple layers of the wrapped substrate, or the like. Mandrel 56 may then be removed from the fixed substrate 40, exposing an interior channel 69 defined by some or all of the surface 42. Preferably, traces 44 are wrapped so that they are exposed on an inner surface of channel 60.

When substrate 40 has been formed to the desired tapering conical shape by wrapping the substrate over mandrel 56, traces 44 can form a series of concentric rings of decreasing radius. While a conical form is shown, alternative shapes may also be used, including tapering shapes having square, triangular, or other cross-sectional shapes having flat portions connected by angles. Such angles may be formed by folding substrate 40 over a corner an appropriately shaped tapering mandrel. Oval and other rounded cross-sections may also be employed, as well as combinations of rounded and flat-sided cross-sectional shapes. Similarly, while the exemplary embodiment includes a tapering cross-section, it may be possible to effect focusing by varying the width (or other dimensions and/or properties) of traces 46 along axis 58, by varying the electrical potentials applied to the individual traces, or the like. Regardless, unlike a reflectron, the structures in the present invention will preferably be arranged and driven so that charged particles enter a channel 60 disposed within wrapped substrate 40 at a first end 62, will typically be focused towards axis 58 as they advance along the ion flight path 20, and will exit channel 60 through substrate 40 adjacent a second end 64. A cross-section of the ion stream exiting end 64 of focusing assembly 24 will be smaller than a cross-section of the ion stream entering the focusing assembly at end 62.

A potential source for driving film assembly 24 is schematically illustrated in FIG. 5. For driving traces (shown here in a schematic flat-panel view) which are rolled to form conductive loops having diameters ranging from about 1 millimeter at end 64 to about millimeters at end 62, an RF voltage may be generated in a signal generator 70 and amplified with an amplifier 72. The amplified signal may be then matched and balanced with a RF high Q head 74. A series of compacitors 76 may be used to apply the RF signal to each line or loop 46. Preferably, adjacent conductive lines or loops 46a, 46b (Generally referred to as loops or lines 46) are driven out of phase, with the adjacent lines or loops ideally being 180 degrees out of phase relative to each other.

At least some of these electrical driving components may be incorporated into a board 78, which will include components here shown separately (for ease of illustration) as constituent boards 78a and 78b. This allows a DC voltage supply 82 to simultaneously provide a DC voltage to a voltage divider 84, which can then feed divided voltages to a series of resistors 86. Resistors 86, in turn, feed varying DC voltages to traces 44, with the DC voltages varying along axis 58. The exemplary described structure might have a DC voltage at a trace 48a along end 62 of about 500 to about 800 volts, with a DC voltage of about 100 to about 200 volts at a trace adjacent end 64. For such an embodiment, using an RF frequency of about 950 kilohertz, focusing current may range from about 0 to about 5 nA with RF voltage ranging to about 0 to about 4 kV, the focusing current typically varying roughly proportionally with the voltage.

As noted above, FIG. 5 is shown schematically with board 78 separated into constituent boards 78a and 78b. The use of driving boards would typically be integrated into a single structure coupled to connector portion 52 of substrate 40. Both rolled ends of the substrate need not be connected directly to separate driving boards, nor do the ends of the traces within the rolled body need to be connected to a separate lead, the adjacent layers of substrate material, or the like.

An ion focusing electrical potential source similar to that illustrated in FIG. 5 is more fully described in U.S. Pat. No. 6,107,628. This reference also describes alternative potential sources which may be used with the flexible ion focusing assembly of the present invention. By bending flexible substrate 40 so as to form loops of conductive lines 46, a series of conductive loops may be defined with each loop having a cross-section that is smaller than the cross-section of the previous loop along the ion flight path. By applying an RF voltage to each loop so that the voltage is out of phase with the adjacent loops, preferably with the RF voltages of adjacent loops being out of phase by between 90 and 270 degrees, and ideally with adjacent RF loops being of phase by 180 degrees, an RF field may be created along surface 42 defining channel 60. This RF field may constrain charged particles by the effective repulsion or “pseudo potential” arising from the RF field near the conductive material of the traces. Charged particles will thereby tend to be repulsed from the surface 42 near the traces, and will tend to be confined to an inner region within tapering channel 60 which is relatively field free. Charged particles driven through the ion focusing assembly 24 are thereby focused into a more dense particle beam at end 64.

In some embodiments of system 10, the pressure differential and entrainment of the charged particles into bath gas flowing from chamber 18 of ion source 12 toward the lower pressure environment of chamber 22 within analyzer 14 may be sufficient to advance the charged ion particles along ion flight path 20, thereby affecting focusing of the entrained ion beam.

By providing a DC potential gradient across the adjacent loops of the ion focusing assembly 24, charged particles may also be driven through the assembly along an ion flight path extending along axis 58. Each loop may therefore have a time variant voltage corresponding to the summation of the DC voltage applied to that loop, together an RF potential component. The simultaneous constraining forces supplied by the RF current and the driving force supplied by the DC gradient thus act to drive and funnel the charged particles through the ion focusing assembly. The electrical driving provided by the DC potentials may be employed with or without the use of gas flow entrainment.

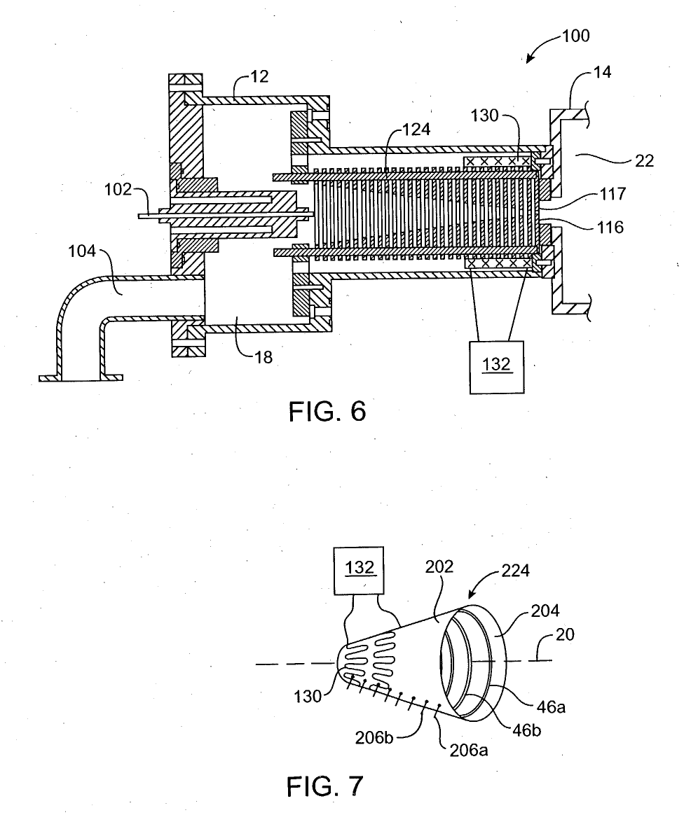

Referring now to FIG. 6, an alternative ion focusing structure 100 generally includes an ionization source 12 into which sample materials are injected via a capillary 102. Vacuum within source chamber 18 is maintained via an elbow pumping port 104. The ions here progress via an interface 116 having an orifice 117 to an analyzer 14. Ion focusing device 124 is defined by a series of ring electrodes, with each ring having an aperture therethrough. The ion focusing assembly 124 may be constructed by assembling the metallic rings along ceramic rods with insulating spacers to separate each ring from the next. Similar construction techniques have been used for ion manipulation elements such as Einzel lens assemblies, reflectrons, and the like. Such structures tend to be relatively costly, and provided limited design flexibility due to manufacturing limits on the use of ceramic rings. As a result, ion focusing assembly 128 and the mass spectrometry 100 using that assembly will tend to be both heavy and fragile. The structure, assembly, and use of stacked-ring ion focusing assemblies is more fully described in U.S. Pat. No. 6,107,628.

Advantageously, mass spectrometer system 100 may reduce or eliminate the need for a separate heated capillary by heating the ion beam along at least an axial portion of ion-focusing assembly 124. Optionally, a heater 130 extends along at least a portion of assembly 124. Heater 130 will typically extend along at least a portion or all of the axial length of focusing assembly 124, and may extend axially upstream and/or downstream of the focusing assembly. Heater 130 may be driven by a heater driver 132, with the heater optionally comprising a resistive heater disposed about the axis of the ion flight path.

A combination of the heated ion funnel of FIG. 6 and the printed circuit board focusing electrode technology of FIGS. 1-5 is schematically illustrated in FIG. 7. In this embodiment, an alternative focusing ion assembly 224 makes use of a tapering non-conductive ceramic substrate 202. Traces are disposed along an inner surface 204 of substrate 202 so as to define lines or loops of conductive material 46a, 46b, . . . . The traces may be deposited in (or etched) after formation of the tapering substrate shape, or may be formed on the substrate material for subsequent bending of the substrate material about axis 20, after which the substrate may be hardened to its desired tapering form. Connector leads 206a, 206b, . . . extend through substrate 202 for coupling of the two focusing potential source 26. As described above, a resistive (or other) heater 130 is disposed around axis 20 of an optical path traversing through the focusing assembly.

While the exemplary embodiments have been described in some detail for clarity of understanding and by way of example, a variety of modifications, changes, and adaptations will be obvious to those with skill in the art. For example, rather than forming concentric rings, some or all of the traces may form tapering helical coils within an inner surface of the tapering formed substrate, with the traces preferably forming at least two axially separated coils interleaved along the inner channel surface so as to facilitate the application of out-of-phase potentials. Hence, the scope of the present application is limited solely by the appended claims.

What is claimed is:

1. A method for fabricating an instrument, the method comprising:
forming electrically conductive traces on a surface of a substrate;
forming the substrate so as to define a channel about an axis;
positioning the substrate along an ion flight path traversing an interface between a first chamber and a second chamber, wherein the channel of the positioned substrate extends upstream of the interface and around the flight path with the conductive traces separated axially and extending circumferentially about the path; and
coupling a potential source to the traces such that ions from the first chamber are focused along the axis by electrical potentials of the traces as the ions traverse through the channel and advance to the second chamber via the interface.

2. The method of claim 1, wherein the substrate comprises a pliable substrate, and wherein the substrate is formed to define the channel by bending the substrate about the axis.

3. The method of claim 2, wherein the substrate bends so as to form a tapering channel having a first channel end and a second channel end smaller than the first end, and wherein the substrate is positioned with the first end upstream of the second end along the ion flight path.

4. The method of claim 2, wherein the substrate is bent by wrapping the substrate about a tapering mandrel so that the traces are disposed on an inner surface of the wrapped substrate.

5. The method of claim 4, wherein the tapering mandrel has a conical shape, and further comprising removing the tapering mandrel from within the wrapped substrate.

6. The method of claim 5, wherein the substrate has a connector portion, wherein the connector portion is disposed along an outer edge of the wrapped substrate, and wherein the coupling of the potential source comprises coupling the connector portion of the substrate to the potential source.

7. The method of claim 1, wherein the interface comprises an orifice separating an ion source environment from an analyzer environment and wherein the electrical potentials comprise RF potentials, and further comprising focusing ions from a first ion stream cross-section adjacent an upstream end of the substrate to a second ion stream cross-section adjacent the orifice by applying the electrical potentials to the traces so that axially adjacent traces are out of phase, the second ion stream cross-section being more concentrated than the first ion stream cross-section.

8. The method of claim 1, further comprising heating the ions as they travel within the substrate.

9. The method of claim 8, wherein the substrate comprises a thermal conductor, and wherein the traces are formed after the substrate defines the channel.

10. The method of claim 1, wherein the substrate becomes charged through ion collision during use, and further comprising draining the collision charge from the substrate.

11. An instrument comprising:
an ion source generating ions in a source environment;
an analyzer receiving the ions into an analyzer environment;
an interface disposed along an ion flight path between the source and the analyzer, the interface at least in part separating the analyzer environment from the source environment;
an ion concentrator disposed along the ion flight path upstream of the interface, the ion concentrator having a substrate and a plurality of electrically conductive traces, the substrate having an upstream end and a downstream end with an axis therebetween along the ion flight path, the substrate having a substrate surface formed about the axis so as to define an ion channel, the traces extending circumferentially along the substrate surface and separated axially; and
circuitry coupled to the traces to apply electrical potentials for focusing the ions from an initial cross-section entering the channel adjacent the upstream end to a focused cross-section exiting the channel adjacent the downstream end.

12. The instrument of claim 11, wherein the substrate and the traces are included within a pliable subassembly, the substrate wrapped circumferentially about the axis.

13. The instrument of claim 12, wherein the channel of the substrate has an upstream channel cross-section adjacent the upstream end and a downstream channel cross-section adjacent the downstream end, the downstream channel cross-section being smaller than the upstream channel cross-section so that the channel tapers radially inwardly as the ions advance, the channel having a funnel shape.

14. The instrument of claim 11, further comprising a heater extending along at least a portion of the substrate so as to desolvate the ions traversing the channel.

15. The instrument of claim 11, wherein the source environment comprises a source pressure during ionization, wherein the analyzer environment comprises an analyzer pressure during analysis, the analyzer pressure being lower than the source pressure, wherein the interface comprises an orifice having a cross-section such that a pressure reduction occurs along the ion flight path, and wherein the focusing effected by the potentials urges ions traveling toward the interface from within the source chamber radially outwardly so as to traverse the orifice.

16. The instrument of claim 11, wherein the traces define at least 5 circumferential loops, and wherein the circuitry applies RF potentials to the traces so that potentials of axially adjacent loops are out of phase, the RF potentials having amplitudes and frequencies so as to induce pseudo potential repulsion between the ions and surfaces of the loops.

17. The instrument of claim 15, wherein the circuitry applies axially varying DC potentials superimposed with the RF potentials applied to the loops, the DC potential urging the ions along the stream.

18. The instrument of claim 11, wherein the substrate comprises a material having a resistivity higher than the traces and sufficiently low to allow ion collision charges imposed on the substrate during use to be drained, and further comprising a collision charge drain conductor coupled to the substrate.

19. An improved ion focusing device comprising an ion concentrator disposed along an ion flight path having an axis, the ion concentrator having an upstream end and a downstream end with an ion channel extending along the axis therebetween, a plurality of electrical conductors along the channel, each electrical conductor extending circumferentially about the ion flight path, the electrical conductors defining a first ion stream cross-section adjacent the upstream end and a second ion stream cross-section adjacent the downstream end, the second cross-section being smaller than the first cross-section, the electrical conductors separated axially so that adjacent electrical conductors accommodate axially out-of-phase RF potentials, and a heater disposed along the ion channel, the heater configured to transmit thermal energy to ions traversing the channel to desolvate the ions.

20. The improved ion focusing device of claim 19, wherein the electrical conductors each comprise a metal body having a passage therethrough, the passages defining the ion channel.

21. The improved ion focusing device of claim 19, wherein the conductors comprise traces of electrical conducting material disposed on a non-conductive substrate, the substrate extending around the ion channel.

22. The improved ion focusing device of claim 21, wherein the substrate comprises a ceramic.

23. The improved ion focusing device of claim 19, wherein the heater comprises an electrical resistor disposed around the channel.

24. The improved ion focusing device of claim 19, wherein the thermal energy to the ions from the heater is sufficient to desolvate the ions without the use of a heated capillary or drying gas.
